(19) United States
(12) Patent Application Publication
(10) Pub. No.: US 2014/0238256 A1
(43) Pub. Date: Aug. 28, 2014

(54) ENVIRONMENT FRIENDLY WATERLESS OFFSET PLATE

(71) Applicants: Haihua Zhou, Beijing (CN); Yanlin Song, Beijing (CN)

(72) Inventors: Haihua Zhou, Beijing (CN); Yanlin Song, Beijing (CN)

(73) Assignee: Institute of Chemistry, Chinese Academy of Sciences, Beijing (CN)

(21) Appl. No.: 14/352,932

(22) PCT Filed: Sep. 7, 2012
(86) PCT No.: PCT/CN2012/081107

§ 371 Date: Apr. 18, 2014

(30) Foreign Application Priority Data
Oct. 24, 2011 (CN) 201110325920.7

(51) Int. Cl. B41N 1/00

(52) U.S. Cl. CPC B41N 1/00
USPC 101/395

(57) ABSTRACT

Disclosed is an environment friendly waterless offset plate. The waterless offset plate is formed by: coating a base coating on a surface of a metal plate substrate not subject to electrolytic graining and/or anodic oxidation treatment but subject to oil-removal solution immersion, coating a diazonaphthoquinone light-sensitive adhesive layer on a surface of the base coating, coating an ink-repulsive layer on a surface of the diazonaphthoquinone light-sensitive adhesive layer, and further covering a polymer protective film on a surface of the ink-repulsive layer. The waterless offset plate has a good printability, and has a pressrun up to 10 to 30 thousand copies.

### FIELD OF THE INVENTION

The present invention belongs to printing plate field, particularly relates to an environment friendly waterless offset plate, more particularly relates to an environment friendly waterless offset plate obtained by coating a base coat layer on the surface of a metal plate substrate not subjected to electrolytic graining and anodic oxidation treatment, coating a photosensitive adhesive layer on the surface of the base coat layer, coating an ink-repulsive layer on the surface of the photosensitive adhesive layer, and further covering a polymer protective film on the surface of the ink-repulsive layer.

### BACKGROUND OF THE INVENTION

Offset lithographic printing is predominant in the printing industry in China, owing to its outstanding performance. At present, the existing printing plate substrates are mainly aluminum plate substrates. Alternatively, other metal plate substrates, such as copper plate substrates or zinc plate substrates, can also be used. To improve the pressrun and resolution of aluminum plate substrates, the aluminum plate substrates are usually treated by anodic oxidation and graining (see Patent Document CN85100875A). Investigations have shown: in a large-size anodic oxidation treatment plant for aluminum plate substrates, the electric power consumption is approx. 2 million kWh/month, the cost is approx. 160,000 USD/month, the waste acid liquid discharged per 10,000 m² aluminum plate substrates is approx. 2 tons, and the waste alkali liquid discharged per 10,000 m² aluminum plate substrate is approx. 3 tons. The large amount of discharged waste acid liquid and waste alkali liquid results in severe environmental pollution.

Waterless offset technology doesn't require water or fountain solution and doesn't have ink emulsification phenomenon in the printing process; therefore, the prints have high quality and high resolution. Since the plate substrates don't have to be treated by electrolytic graining and/or anodic oxidation, environmental pollution is reduced. Therefore, waterless offset technology is widely applied in developed countries. Waterless offset printing is helpful for improving product quality, and is especially suitable for printing of high LPI products, such as picture albums, stamps, wall calendars, and product catalogs, etc. As the market economy in China develops and opens to the outside world, our export commodities face competition in international markets. Therefore, printed packaging and decorative materials must be exquisite and high-class ones. Waterless offset printing is helpful for increasing competitiveness for our printed products in the international markets.

The object of the present invention is to provide an environment friendly waterless offset plate prepared by coating a base coat layer on the surface of a metal plate substrate not subject to electrolytic graining and/or anodic oxidation treatment, coating a photosensitive adhesive layer on the surface of the base coat layer, coating an ink-repulsive layer on the surface of the photosensitive adhesive layer, and further covering a protective film on the surface of the ink-repulsive layer. After the waterless offset plate dries, when used, the protective film can be removed, and the waterless offset plate can be directly treated by exposure, development, and fixation, etc. for plate making. Then, the plate with images and text can be used directly in a printing press for printing. The obtained waterless offset plate has high printing adaptability and the pressrun is up to 10,000˜30,000 press-runs.

### SUMMARY OF THE INVENTION

The primary object of the present invention is to provide an environment friendly waterless offset plate, which eliminates the potential risk of environmental pollution caused by waste acid liquid and waste alkali liquid produced during electrolytic graining and/or anodic oxidation of metal plate substrates.

The environment friendly waterless offset plate is obtained by coating a base coat layer on the surface of a metal plate substrate not subjected to electrolytic graining and/or anodic oxidation treatment but subjected to oil-removal solution immersion instead, coating a diazonaphthoquinone photosensitive adhesive layer on the surface of the base coat layer, and coating an ink-repulsive layer on the surface of the diazonaphthoquinone photosensitive adhesive layer.

The base coat layer is preferably in thickness of 1˜20 μm; the diazonaphthoquinone photosensitive adhesive layer is preferably in thickness of 10˜50 μm; the ink-repulsive layer is preferably in thickness of 2˜5 μm.

The oil-removal solution is 0.1˜40 wt % water solution of an alkaline substance. The alkaline substance is at least one selecting from the group consisting of sodium hydroxide, potassium hydroxide, sodium carbonate, potassium carbonate, sodium bicarbonate, potassium bicarbonate, sodium phosphate, potassium phosphate, sodium hydrogen phosphate, potassium hydrogen phosphate, sodium dihydrogen phosphate, and potassium dihydrogen phosphate.

The base coat layer is a coating formed by coating a base coat liquid constituted by 0˜50 wt % (preferably 0.01˜40 wt %, more preferably 10˜30 wt %) polymer, 0.01˜20 wt % metal adhesion promoter, 0.01˜20 wt % anti-halation nanometer particles, and organic solvent that accounts for the remaining percentage on the surface of the metal plate substrate and then drying the coating; usually, the drying process is drying for 0.5˜3 days at room temperature ˜100° C., and the room temperature can be 15-40° C., for example.

The polymer in the base coat layer can be any ordinary polymer that can form a film and bond the anti-halation nanometer particles to the metal substrate, preferably is at least one selecting from the group consisting of polyvinyl butyral, polyurethane, polyacrylic resin, polymethacrylic resin, phenolic resin, epoxy resin, melamine formaldehyde resin, polyester resin, alkyd resin, and ethylene-vinyl acetate copolymer. The phenolic resin is preferably phenolic novolac resin. In case the phenolic resin is phenolic novolac resin, preferably the phenolic resin is used in combination with epoxy resin. The urethane resin can be selected from ordinary resins obtained by condensing isocyanate and hydroxyl compound, wherein, the isocyanate and hydroxyl compound can be a conventional choice in the art, and there is no special restriction on them. For example, the isocyanate can be selected from isophorone diisocyanate, toluene diisocyanate, diphenylmethane diisocyanate, and dicyclohexylmethane diisocyanate; the hydroxyl compound can be selected from polycarbonate dial, polyether triol, polyether diol (e.g., polyoxypropylene glycol, polytetrahydrofuran glycol), polyester diol, polypropylene glycol, polyethylene glycol, and polyacrylate polyol.

The epoxy resin can be any ordinary epoxy resin in the art, and there is no special restriction on it here. For example, the epoxy resin can be glycidol ether epoxy resin, glycidol ester epoxy resin, glycidol amine epoxy resin, linear aliphatic epoxy resin, or alicyclic epoxy resin. The polyester resin can be any ordinary polyester resin, for example, it can be selected from saturated polyester resin and unsaturated polyester resin. The alkyd resin can be selected from medium oil alkyd resin, long oil alkyd resin, and short oil alkyd resin, for example.

The metal adhesion promoter is at least one selecting from the group consisting of silane coupling agent, titanate coupling agent, aryl phosphate ester, alkyl phosphate ester, zirconium aluminate, zirconate, hydroxyethyl acrylate, hydroxy-propyl acrylate, dodecyl acrylate, octadecyl acrylate, 2-ethylhexyl acrylate, butyl acrylate, ethoxylated cyclohexanol acrylate, isoborneol acrylate, epoxy acrylic ester, ethoxy-ethyl acrylate, 2-phenoxy-ethyl methacrylate, polyethylene glycol-200 diacrylate, polyethylene glycol-400 diacrylate, polyethylene glycol-600 diacrylate, tripropylene glycol diacrylate, dipropylene glycol diacrylate, propylene glycol diacrylate, neopentyl glycol diacrylate, neopentyl glycol benzoate acrylate, propoxy-2 neopentyl glycol diacrylate, nonyl-phenoxy polyethylene glycol acrylate, 1,3-butanediol diacrylate, phthalate diglycol diacrylate, phthalate tripropylene glycol diacrylate, ethylene glycol diacrylate, diethylene glycol diacrylate, triethylene glycol diacrylate, tetraethylene glycol diacrylate, 1,6-hexanediol diacrylate, ethoxylated 1,6-hexanediol diacrylate, 1,4-butanediol diacrylate, ethoxy-4 bisphenol A diacrylate, acryloyl morpholine, trimethylolpropane triacrylate, ethylene oxide-modified trimethylolpropane triacrylate, ethoxylated trimethylolpropane triacrylate, propoxylated trimethylolpropane triacrylate, propoxylated 3-glycerol triacrylate, pentaerythritol tetraacrylate, pentaerythritol triacrylate, and dipentaerythritol pentaacrylate. The ethylene oxide-modified trimethylolpropane triacrylate is obtained by controlling ethylene oxide and trimethylolpropane triacrylate to contact with each other under an alkaline condition, wherein, the weight ratio of ethylene oxide to trimethylolpropane triacrylate can be 3˜9:1, and the contact temperature can be any ordinary choice in the art, such as 50˜100° C.

The aryl in the aryl phosphate ester is selected from phenyl, tolyl, or naphthyl.

The alkyl in the alkyl phosphate esters is selected from C1-C20 alkyl chains.

The zirconium aluminate is selected from zirconium potassium aluminate, zirconium sodium aluminate, or a mixture thereof.

The zirconate is at least one selecting from the group consisting of M²⁺ZrO₃, M³⁺Zr₂O₇, M₄³⁺Zr₃O₁₂, Ti—ZrO₄, V₂ZrO₇, Nb₁₀ZrO₂₇, MO₂ZrO₄, and W₂ZrO₈, wherein, the M in M²⁺ZrO₃ is one selecting from bivalent magnesium, barium, strontium, and calcium, the M in M³⁺Zr₂O₇ is one selecting from lanthanum, cerium, neodymium, and samarium, and the M in M₄³⁺Zr₃O₁₂ is selected from scandium or ytterbium.

The anti-halation nanometer particles are in 10˜1,000 nm particle size, and are at least one selecting from the group consisting of aluminum oxide nanometer particles, zinc oxide nanometer particles, silicon dioxide nanometer particles, zirconium oxide nanometer particles, titanium oxide nanometer particles, and silicon carbide nanometer particles.

The organic solvent in the base coat liquid is selected from alcohol, ketone, ether, ester, or hydrocarbon.

The alcohol is selected from lower alcohol or polyhydric alcohol, preferably C1˜C5 monohydric alcohol or C2˜C5 dihydric alcohol or trihydric alcohol. The ketone is one selecting from acetone, butanone, cyclohexanone, and n-methylpyrrolidone (NMP). The ether is selected from alcohol ethers, preferably is one selecting from ethylene glycol monomethyl ether, ethylene glycol monoethyl ether, ethylene glycol mono-n-dutyl ether, glycol dimethyl ether, ethylene glycol diethyl ether, propylene glycol monomethyl ether, propylene glycol monoethyl ether, propylene glycol dimethyl ether, and propylene glycol diethyl ether. The ester is selected from carboxylic acid esters, preferably is one selecting from ethyl acetate, methyl acetate, ethyl formate, butyl formate, and propylene glycol monomethyl ether acetate. The hydrocarbon is one selecting from normal heptane, normal hexane, methyl benzene, and dimethyl benzene.

The diazonaphthoquinone photosensitive adhesive layer is a coating formed by spreading a photosensitive adhesive constituted by 5˜30 wt % film forming resin, 1˜20 wt % diazonaphthoquinone photosensitive resin, 0.01˜0.5 wt % background dye, 0.01˜0.5 wt % acid generator, and organic solvent that accounts for the remaining percentage on the surface of the base coat layer and then drying the coating; the drying process is preferably drying for 2˜15 min at 60˜150° C. temperature.

The film forming resin is at least one selecting from the group consisting of phenolic resin, urethane resin, epoxy resin, alkyd resin, acrylic resin, polyvinyl formal, polyvinyl acetal, and polyvinyl butyral. The phenolic resin is preferably phenolic novolac resin. In case the phenolic resin is phenolic novolac resin, preferably the phenolic resin is used in combination with epoxy resin. The urethane resin can be selected from ordinary resins obtained by condensing isocyanate and hydroxyl compound, wherein, the isocyanate and hydroxyl compound can be a conventional choice in the art, and there is no special restriction on them. For example, the isocyanate can be selected from isophorone diisocyanate, toluene diisocyanate, diphenylmethane diisocyanate, and dicyclohexylmethane diisocyanate; the hydroxyl compound can be selected from polycarbonate diol, polyether triol, polyether diol (e.g., polyoxypropylene glycol, polytetrahydrofuran glycol), polyester diol, polypropylene glycol, polyethylene glycol, and polyacrylate polyol.

The epoxy resin can be any ordinary epoxy resin in the art, and there is no special restriction on it here. For example, the epoxy resin can be glycidol ether epoxy resin, glycidol ester epoxy resin, glycidol amine epoxy resin, linear aliphatic epoxy resin, or alicyclic epoxy resin. The polyester resin can be any ordinary polyester resin, for example, it can be selected from saturated polyester resin and unsaturated polyester resin. The alkyd resin can be selected from medium oil alkyd resin, long oil alkyd resin, and short oil alkyd resin, for example.

The diazonaphthoquinone photosensitive resin is obtained through a reaction between diazonaphthoquinone sulfuryl chloride and a resin ester catalyzed by 0.1˜50 wt % water solution of an alkaline substance; the grafting ratio of diazonaphthoquinone sulfuryl chloride on the resin ester is 10˜40 wt %; the photosensitive groups in diazonaphthoquinone sulfuryl chloride are diazonaphthoquinone groups; the resin ester is selected from phenolic novolac resin or phenol resins; the alkaline substance is at least one selecting from the group consisting of sodium carbonate, potassium carbonate, sodium bicarbonate, potassium bicarbonate, sodium hydroxide, potassium hydroxide, sodium phosphate, potassium phosphate, sodium hydrogen phosphate, potassium hydrogen phosphate, sodium dihydrogen phosphate, and potassium dihydrogen phosphate. In the present invention, the phenol resin is prepared through a reaction between pyrogallol and formaldehyde at 1:0.1-10 mole ratio under acidic or alkaline condition, and the reaction temperature can be any ordinary choice in the art, and usually can be 50-100° C.

The background dye is one selecting from oil yellow, oil red G, oil violet red, oil blue B, oil ethereal blue, solvent blue RS, aniline black, oil black, solvent black 827, solvent black 834, Victoria blue, methyl violet, basic brilliant blue, and crystal violet or methyl violet.

The acid generator is selected from onium salt, triazine acid generator or sulphonic acid ester.

The onium salt can be any ordinary onium salt that can generate acid, and is preferably selected from sulfonium salt, iodonium salt, or a mixture thereof. The triazine acid generator is selected from 2,4-di-(trichloromethyl)-6-p-methoxy-styryl-s-triazine, 4,6-di-(trichloromethyl)-1,3,5-triazine, or a mixture thereof. The sulphonic acid ester is at least one electing from the group consisting of N-hydroxy phthalimide p-toluene sulfonate, N-p-toluenesulfonyloxy phthalimide, N-trifluoromethane sulfonyloxy succinimide, N-trifluoromethane sulfonyloxy naphthalimide, and dinitrobenzyl p-toluene sulfonate.

The organic solvent in the photosensitive adhesive is at least one selecting from the group consisting of glycol ether (e.g., ethylene glycol monoethyl ether, ethylene glycol diethyl ether), propylene glycol monomethyl ether (e.g., propylene glycol monomethyl ether, propylene glycol dimethyl ether), propylene glycol ether (e.g., propylene glycol monoethyl ether, propylene glycol diethyl ether), diethylene glycol methyl ether (e.g., diethylene glycol monomethyl ether, diethylene glycol dimethyl ether), ethylene glycol mono-n-dutyl ether, ethylene glycol dimethyl ether, propylene glycol isopropyl ether, propylene glycol monobutyl ether, propylene glycol dibutyl ether, diethylene glycol monoethyl ether, diethylene glycol diethyl ether, diethylene glycol monobutyl ether, dipropylene glycol monomethyl ether, dipropylene glycol dimethyl ether, dipropylene glycol diethyl ether, dipropylene glycol dipropyl ether, dipropylene glycol monoethyl ether, dipropylene glycol monobutyl ether, triethylene glycol monoethyl ether, triethylene glycol monobutyl ether, tripropylene glycol monomethyl ether, ethylene glycol, propylene glycol, glycerol, diethylene glycol, triethylene glycol, propylene glycol monomethyl ether acetate, ethylene glycol monomethyl ether acetate, and butanone.

The ink-repulsive layer is a coating formed by spreading an ink-repulsive liquid constituted by 5˜30 wt % silicone rubber or fluoro resin, 0.01˜2 wt % curing agent, and organic solvent that accounts for the remaining percentage on the surface of the diazonaphthoquinone photosensitive adhesive layer and then drying the coating; the drying process is preferably drying for 0.5˜3 days at room temperature ˜100° C.

The silicone rubber can be any ordinary silicone rubber that can form a hydrophobic surface. Preferably, the viscosity range of the silicone rubber is 1,000˜80,000 cp.

The fluoro resin is one selecting from organo-fluorine modified acrylic resin (i.e., fluorine acrylic resin), fluorosilicone epoxy resin, and fluoro-rubber.

The curing agent for curing the silicone rubber is one selecting from ethyl orthosilicate, silicon-nitrogen polymer expressed by the following molecular formula (I), butyltin dilaurate, dibutyltin dilaurate, hydrosilicone oil, and chloroplatinic acid.

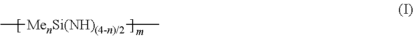

In the formula (I), n=1˜2, and m=100˜200.

The silicon-nitrogen polymer expressed by the above formula (I) can be synthesized with the synthesis method for silicon-nitrogen polymer C disclosed in Chinese patent 93117927.0, i.e., add 1 mol MeSiCl₃, 0.5 mol Me₂SiCl₂, and 800 mL methyl benzene into a three-neck flask, blow NH₃ into the solution in the three-neck flask for 16 h while stirring and cooling by means of water bath, then lower the NH₃ blowing rate appropriately and further blow NH₃ for about 2 h, terminate the reaction, filter off ammonium chloride, wash the ammonium chloride with methyl benzene for three cycles, and then remove the solvent and low polymers by distillation and reduced pressure distillation, to obtain the silicon-nitrogen polymer expressed by the above formula (I).

The curing agent for curing the fluoro resin is one selecting from hexamethylene diisocyanate, low molecular weight polyimide (amine value: 300˜400 mg KOH/g) and dicyandiamide.

The organic solvent in the ink-repulsive liquid is one selecting from n-decane, octane (i.e., n-octane), n-heptane, n-hexane, n-pentane, dimethyl benzene, isoparaffin-E, isoparaffin-G, isoparaffin-H, and ethyl acetate.

The surface of the ink-repulsive layer is further covered with a polymer protective film.

The polymer protective film is preferably in thickness of 1˜20 μm.

The polymer protective film is one selecting from polyvinyl chloride film, polyethylene film, polypropylene film, polystyrene film, polyester film, and nylon film.

The metal plate substrate is aluminum plate substrate, zinc plate substrate, or alloy plate substrate.

The alloy plate substrate is a silicon dioxide-aluminum alloy plate substrate that contains 30˜60 wt % silicon dioxide, or an aluminum-zinc alloy plate substrate that contains 1˜3 wt % zinc, or a ferro-aluminum alloy plate substrate that contains 0.1˜1 wt % iron.

The method for preparation of the environment friendly waterless offset plate in the present invention is: spreading a base coat liquid on the surface of a printing metal plate substrate not subject to electrolytic graining and/or anodic oxidation treatment but subject to oil-removal solution immersion and drying the coating to obtain a base coat layer, spreading a photosensitive adhesive that contains diazonaphthoquinone photosensitive resin on the surface of the base coat layer and drying the coating after spreading to obtain a diazonaphthoquinone photosensitive adhesive layer, spreading an ink-repulsive liquid on the surface of the diazonaphthoquinone photosensitive adhesive layer and drying the coating at room temperature in the air to obtain an ink-repulsive layer, and then covering a thin polymer protective film in thickness of 1˜20 μm on the surface of the obtained ink-repulsive layer.

When the environment friendly waterless offset plate is to be used, if there is a polymer protective film, it should be removed first, then, the environment friendly waterless offset plate can be treated through a plate making process, including exposure, development, and fixation, etc.; next, the plate with images and text can be directly used for printing in a printing press. The environment friendly waterless offset plate provided in the present invention has high printing adaptability and pressrum is up to 10,000˜30,000 press-runs. Since the plate substrate doesn't have to be treated by electrolytic graining and/or anodic oxidation, potential environmental pollution can be reduced greatly.

### DETAILED DESCRIPTION OF THE EMBODIMENTS

Here under the present invention will be further detailed in examples. It should be appreciated that the following examples don't constitute any limitation to the protected scope of the present invention, and any modification or improvement made without departing from the spirit of the present invention shall be deemed as falling into the protected scope of the present invention.

### Example 1

Preparation of base coat liquid: mix 5 wt % polyvinyl butyral (purchased from Beijing Chemical Reagent Co., Ltd., the viscosity measured with a QND-4 viscosity meter at 25° C. with the method specified in GB/T 1723-93 is 100-120 s), 0.1 wt % silane coupling agent (purchased from Jiangsu Chenguang Coupling Agent Co., Ltd., with brand name as KH550), 20 wt % anti-halation zinc oxide nanometer particles in 10 nm particle size, and ethyl alcohol that accounts for the remaining percentage, stir well, and grind, so that the components in the base coat liquid are dissolved and dispersed completely.

Preparation of photosensitive adhesive including diazonaphthoquinone photosensitive resin: mix 5 wt % phenolic novolac resin (purchased from Shandong Shengquan Chemical Co., Ltd., with brand name as SH-1), 3 wt % diazonaphthoquinone photosensitive resin, 0.05 wt % oil blue B, 0.05 wt % 2,4-di-(trichloromethyl)-6-p-methoxy-styryl-s-triazine, and glycol ether that accounts for the remaining percentage, then dissolve the components completely, and then filter the mixture, wherein:

The diazonaphthoquinone photosensitive resin is obtained through a reaction between diazonaphthoquinone sulfuryl chloride and phenolic novolac resin (purchased from Shandong Shengquan Chemical Co., Ltd., with brand name as SH-1) catalyzed by 0.1 wt % water solution of sodium hydroxide, and the grafting ratio of the diazonaphthoquinone sulfuryl chloride on the phenolic novolac resin is 10 wt %; the photosensitive groups in the diazonaphthoquinone sulfuryl chloride are diazonaphthoquinone groups.

Preparation of ink-repulsive liquid: mix 10 wt % silicone rubber (purchased from Shishi Luyu Chemical Trading Co., Ltd., viscosity: 1,000 cp.), 0.01 wt % ethyl orthosilicate, and n-decane that accounts for the remaining percentage to obtain an ink-repulsive liquid.

Wash an aluminum plate substrate not subjected to electrolytic graining and anodic oxidation treatment with water, treat for 100 s in 0.1 wt % water solution of sodium carbonate to de-oil, and then wash with water again, to remove residual alkaline liquid, and then dry.

Coat the base coat liquid by spin-coating on the surface of the de-oiled aluminum plate substrate, and then dry the aluminum plate substrate for 20 min at 50° C. to obtain a base coat layer in thickness of 1 μm; coat the photosensitive adhesive including diazonaphthoquinone photosensitive resin by spin-coating on the surface of the base coat layer, and then dry for 15 min at 60° C. to obtain a photosensitive adhesive layer in thickness of 50 μm; coat the ink-repulsive liquid by spin-coating on the surface of the dry diazonaphthoquinone photosensitive adhesive layer, and then lay aside for 3 days at room temperature, to obtain an ink-repulsive layer in thickness of 2 μm. Cover a polypropylene film in thickness of 1 μm on the surface of the ink-repulsive layer, so as to obtain an environment friendly waterless offset plate.

### Example 2

Preparation of base coat liquid: mix 50 wt % unsaturated polyester resin (purchased from Jinan Oasis Composite Materials Co., Ltd., with brand name as 902#), 20 wt % titanate coupling agent (purchased from Nanjing Shuguang Chemical Group Co., Ltd., with brand name as SG-TnBT), 0.01 wt % anti-halation aluminum oxide in 1,000 nm particle size, and dimethyl benzene that accounts for the remaining percentage, stir well, and grind, so that the components in the obtained base coat liquid are dissolved and dispersed completely.

Preparation of photosensitive adhesive including diazonaphthoquinone photosensitive resin: mix 30 wt % polyvinyl butyral (purchased from Beijing Chemical Reagent Co., Ltd., the viscosity measured with a QND-4 viscosity meter at 25° C. with the method specified in GB/T 1723-93 is 100-120 s), 10 wt % diazonaphthoquinone photosensitive resin, 0.5 wt % solvent black 827, 0.5 wt % N-hydroxy phthalimide p-toluene sulfonate, and triethylene glycol monobutyl ether that accounts for the remaining percentage, then dissolve the components completely, and then filter the mixture, wherein:

The diazonaphthoquinone photosensitive resin is obtained through a reaction between diazonaphthoquinone sulfuryl chloride and phenol resin (prepared through a reaction between pyrogallol and formaldehyde at 0.1:1 mole ratio under acidic condition at 70° C.) catalyzed by 50 wt % water solution of sodium bicarbonate, and the grafting ratio of the diazonaphthoquinone sulfuryl chloride on the phenol resin is 40 wt %; the photosensitive groups in the diazonaphthoquinone sulfuryl chlorides are diazonaphthoquinone groups.

Preparation of ink-repulsive liquid: mix 30 wt % organo-fluorine modified acrylic resin (purchased from Keyao Chemical Co., Ltd. under Shandong Dongming Petrochemical Group, with brand name as CF-902), 2 wt % hexamethylene diisocyanate, and dimethyl benzene that accounts for the remaining percentage to obtain an ink-repulsive liquid.

Wash a zinc plate substrate not subjected to electrolytic graining and anodic oxidation treatment with water, treat for 5 s in 40 wt % water solution of sodium phosphate to de-oil, and then wash with water again, to remove residual alkaline liquid, and then dry.

Coat the base coat liquid by spin-coating on the surface of the de-oiled zinc plate substrate, and then dry the zinc plate substrate for 2 min at 150° C. to obtain a base coat layer in thickness of 20 μm; coat the photosensitive adhesive including diazonaphthoquinone photosensitive resin by spin-coating on the surface of the base coat layer, and then dry for 2 min at 150° C. to obtain a photosensitive adhesive layer in thickness of 10 μm; coat the ink-repulsive liquid by spin-coating on the surface of the dry diazonaphthoquinone photosensitive adhesive layer, and then lay aside for 0.5 day at 100° C., to obtain an ink-repulsive layer in thickness of 2 μm. Cover a polyvinyl chloride film in thickness of 20 μm on the surface of the ink-repulsive layer, so as to obtain an environment friendly waterless offset plate.

### Example 3

Preparation of base coat liquid: mix 30 wt % phenolic novolac resin (purchased from Shandong Shengquan Chemical Co., Ltd., with brand name as SH-1), 0.2 wt % phenyl phosphate ester, 0.03 wt % anti-halation silicon dioxide in 100 nm particle size, and ethylene glycol monoethyl ether that accounts for the remaining percentage, stir well, and grind, so that the components in the obtained base coat liquid are dissolved and dispersed completely.

Preparation of photosensitive adhesive including diazonaphthoquinone photosensitive resin: mix 20 wt % urethane resin (purchased from Anping Sanlian Filter Materials Co., Ltd., with brand name as 100), 5 wt % diazonaphthoquinone photosensitive resin, 0.1 wt % oil basic brilliant blue, 0.01 wt % 4,6-di-(trichloromethyl)-1,3,5-triazine, and ethylene glycol dimethyl ether that accounts for the remaining percentage, then dissolve the components completely, and then filter the mixture, wherein:

The diazonaphthoquinone photosensitive resin is obtained through a reaction between diazonaphthoquinone sulfuryl chloride and phenolic novolac resin (purchased from Shandong Shengquan Chemical Co., Ltd., with brand name as SH-1) catalyzed by 10 wt % water solution of potassium carbonate, and the grafting ratio of the diazonaphthoquinone sulfuryl chloride on the phenolic novolac resin is 30 wt %; the photosensitive groups in the diazonaphthoquinone sulfuryl chloride are diazonaphthoquinone groups.

Preparation of ink-repulsive liquid: mix 5 wt % silicone rubber (purchased from Shishi Luyu Chemical Trading Co., Ltd., viscosity: 80,000 cp.), 0.25 wt % dibutyltin dilaurate, and n-hexane that accounts for the remaining percentage to obtain an ink-repulsive liquid.

Wash an alloy plate substrate (silicon dioxide-aluminum plate that contains 30˜60 wt % silicon dioxide) not subjected to electrolytic graining and anodic oxidation treatment with water, treat for 10 s in 0.5 wt % water solution of sodium hydroxide, to de-oil, and then wash with water again, to remove residual alkaline liquid, and then dry.

Coat the base coat liquid by spin-coating on the surface of the de-oiled alloy plate substrate, and then dry the alloy plate substrate for 5 min at 100° C. to obtain a base coat layer in thickness of 3 μm; coat the photosensitive adhesive including diazonaphthoquinone photosensitive resin by spin-coating on the surface of the base coat layer, and then dry for 3 min at 100° C. to obtain a photosensitive adhesive layer in thickness of 20 μm; coat the ink-repulsive liquid by spin-coating on the surface of the dry diazonaphthoquinone photosensitive adhesive layer, and then lay aside for 1 day at 80° C., to obtain an ink-repulsive layer in thickness of 3 μm. Cover a polyethylene film in thickness of 10 μm on the surface of the ink-repulsive layer, so as to obtain an environment friendly waterless offset plate.

### Example 4

Preparation of base coat liquid: mix 20 wt % urethane resin (purchased from Yantai Wanhua Polyurethane Co., Ltd., with brand name as WANNATE PM-2025), 0.01 wt % tolyl phosphate ester, 0.05 wt % anti-halation titanium oxide in 200 nm particle size, and n-methylpyrrolidone (NMP) that accounts for the remaining percentage, stir well, and grind, so that the components in the obtained base coat liquid are dissolved and dispersed completely.

Preparation of photosensitive adhesive including diazonaphthoquinone photosensitive resin: mix 15 wt % alkyd resin (purchased from Jiangsu Hualun Chemical Co., Ltd., with brand name as BD251), 6 wt % diazonaphthoquinone photosensitive resin, 0.01 wt % Victoria blue, 0.02 wt % sulfonium salt (purchased from Liyie Chemical Co., Ltd. in Handan Development Zone), and diethylene glycol dimethyl ether that accounts for the remaining percentage, then dissolve the components completely, and then filter the mixture, wherein:

The diazonaphthoquinone photosensitive resin is obtained through a reaction between diazonaphthoquinone sulfuryl chloride and phenol resin (prepared through a reaction between pyrogallol and formaldehyde at 1:10 mole ratio under acidic condition at 70° C.) catalyzed by 3 wt % water solution of potassium phosphate, and the grafting ratio of the diazonaphthoquinone sulfuryl chloride on the phenol resin is 15 wt %; the photosensitive groups in the diazonaphthoquinone sulfuryl chlorides are diazonaphthoquinone groups.

Preparation of ink-repulsive liquid: mix 15 wt % silicone rubber (purchased from Dongguan Hongya OrganicSilicone Co., Ltd., viscosity: 20,000 cp.), 0.75 wt % hydrosilicone oil (purchased from Quzhou Ruilijie Chemical Industry Co., Ltd., with brand name as RLJJ005) and isoparaffin-H that accounts for the remaining percentage (purchased from Shenzhen Goforward Technology Co., Ltd.) to obtain an ink-repulsive liquid.

Wash an alloy plate substrate (aluminum-zinc alloy plate that contains 1˜3 wt % zinc) not subjected to electrolytic graining and anodic oxidation treatment with water, treat for 20 s in 1 wt % water solution of potassium hydroxide to de-oil, and then wash with water again, to remove residual alkaline liquid, and then dry.

Coat the base coat liquid by spin-coating on the surface of the de-oiled alloy plate substrate, and then dry the alloy plate substrate for 4 min at 90° C. to obtain a base coat layer in thickness of 4 μm; coat the photosensitive adhesive including diazonaphthoquinone photosensitive resin by spin-coating on the surface of the base coat layer, and then dry for 5 min at 110° C. to obtain a photosensitive adhesive layer in thickness of 30 μm; coat the ink-repulsive liquid by spin-coating on the surface of the dry diazonaphthoquinone photosensitive adhesive layer, and then lay aside for 2 days at room temperature, to obtain an ink-repulsive layer in thickness of 2 μm. Cover a polystyrene film in thickness of 5 μm on the surface of the ink-repulsive layer, so as to obtain an environment friendly waterless offset plate.

### Example 5

Preparation of base coat liquid: mix 40 wt % polyacrylic resin (purchased from Changzhou Hanguang Paint Co., Ltd., with brand name as AR-2070), 0.02 wt % zirconium potassium aluminate, 0.3 wt % anti-halation zirconium oxide in 500 nm particle size, and acetone that accounts for the remaining percentage, stir well, and grind, so that the components in the obtained base coat liquid are dissolved and dispersed completely.

Preparation of photosensitive adhesive including diazonaphthoquinone photosensitive resin: mix 25 wt % epoxy resin (purchased from Borui Resin Materials Trading Firm in Sanxiang Town, Zhongshan, with brand name as 618), 1 wt % diazonaphthoquinone photosensitive resin, 0.03 wt % crystal violet, 0.2 wt % iodonium salt, and propylene glycol monomethyl ether acetate that accounts for the remaining percentage, then dissolve the components completely, and then filter the mixture, wherein:

The diazonaphthoquinone photosensitive resin is obtained through a reaction between diazonaphthoquinone sulfuryl chloride and phenol resin (prepared through a reaction between pyrogallol and formaldehyde at 1:2 mole ratio under acidic condition at 70° C.) catalyzed by 15 wt % water solution of potassium carbonate, and the grafting ratio of the diazonaphthoquinone sulfuryl chloride on the phenol resin is 35 wt %; the photosensitive groups in the diazonaphthoquinone sulfuryl chlorides are diazonaphthoquinone groups.

Preparation of ink-repulsive liquid: mix 20 wt % fluoro-rubber (purchased from Shandong Huaxia Shenzhou New Materials Co., Ltd., with brand name as FKM-DS2600), 1 wt % dicyandiamide, and ethyl acetate that accounts for the remaining percentage, to obtain an ink-repulsive liquid.

Wash an aluminum plate substrate not subjected to electrolytic graining and anodic oxidation treatment with water, treat for 60 s in 15 wt % water solution of potassium carbonate to de-oil, and then wash with water again, to remove residual alkaline liquid, and then dry.

Coat the base coat liquid by spin-coating on the surface of the de-oiled aluminum plate substrate, and then dry the aluminum plate substrate for 15 min at 70° C. to obtain a base coat layer in thickness of 3 μm; coat the photosensitive adhesive including diazonaphthoquinone photosensitive resin by spin-coating on the surface of the base coat layer, and then dry for 3 min at 120° C. to obtain a photosensitive adhesive layer in thickness of 15 μm; coat the ink-repulsive liquid by spin-coating on the surface of the dry diazonaphthoquinone photosensitive adhesive layer, and then lay aside for 1 day at 90° C., to obtain an ink-repulsive layer in thickness of 3 μm. Cover a polypropylene film in thickness of 2 μm on the surface of the ink-repulsive layer, so as to obtain an environment friendly waterless offset plate.

### Example 6

Preparation of base coat liquid: mix 15 wt % polymethacrylic resin (purchased from Jinan Yuanxiang Chemical Co., Ltd., with brand name as BC-201-805), 0.05 wt % zirconium sodium aluminate, 0.3 wt % anti-halation silicon carbide in 30 nm particle size, and butanone that accounts for the remaining percentage, stir well, and grind, so that the components in the obtained base coat liquid are dissolved and dispersed completely.

Preparation of photosensitive adhesive including diazonaphthoquinone photosensitive resin: mix 20 wt % phenolic novolac resin (purchased from Shandong Shengquan Chemical Co., Ltd., with brand name as SH-1), 6 wt % diazonaphthoquinone photosensitive resin, 0.01 wt % methyl violet, 0.1 wt % 2,4-di-(trichloromethyl)-6-p-methoxy-styryl-s-triazine, and diethylene glycol monoethyl ether that accounts for the remaining percentage, then dissolve the components completely, and then filter the mixture, wherein:

The diazonaphthoquinone photosensitive resin is obtained through a reaction between diazonaphthoquinone sulfuryl chloride and phenolic novolac resin (purchased from Shandong Shengquan Chemical Co., Ltd., with brand name as SH-1) catalyzed by a water solution that contains 8 wt % sodium dihydrogen phosphate and 0.1 wt % potassium hydroxide, and the grafting ratio of the diazonaphthoquinone sulfuryl chloride on the phenolic novolac resin is 20 wt %; the photosensitive groups in the diazonaphthoquinone sulfuryl chloride are diazonaphthoquinone groups.

Preparation of ink-repulsive liquid: mix 8 wt % silicone rubber (purchased from Shishi Luyu Chemical Trading Co., Ltd., viscosity: 4,000 cp.), 0.5 wt % silicon-nitrogen polymer (prepared with the synthesis method for the silicon-nitrogen polymer C disclosed in Chinese patent 93117927.0), and n-pentane that accounts for the remaining percentage, to obtain an ink-repulsive liquid.

Wash an aluminum plate substrate not subjected to electrolytic graining and anodic oxidation treatment with water, treat for 10 s in a water solution that contains 5 wt % potassium carbonate and 0.5 wt % potassium hydroxide to de-oil, and then wash with water again, to remove residual alkaline liquid, and then dry.

Coat the base coat liquid by spin-coating on the surface of the de-oiled aluminum plate substrate, and then dry the aluminum plate substrate for 10 min at 85° C. to obtain a base coat layer in thickness of 4 μm; coat the photosensitive adhesive including diazonaphthoquinone photosensitive resin by spin-coating on the surface of the base coat layer, and then dry for 10 min at 70° C. to obtain a photosensitive adhesive layer in thickness of 40 μm; coat the ink-repulsive liquid by spin-coating on the surface of the dry diazonaphthoquinone photosensitive adhesive layer, and then lay aside for 1.5 days at 80° C., to obtain an ink-repulsive layer in thickness of 5 μm. Cover a polyethylene film in thickness of 3 μm on the surface of the ink-repulsive layer, so as to obtain an environment friendly waterless offset plate.

### Example 7

Preparation of base coat liquid: mix 30 wt % epoxy resin (purchased from Borui Resin Materials Trading Finn in Sanxiang Town, Zhongshan, with brand name as 618), 0.2 wt % barium zirconate, 10 wt % anti-halation aluminum oxide in 50 nm particle size, and ethyl acetate that accounts for the remaining percentage, stir well, and grind, so that the components in the obtained base coat liquid are dissolved and dispersed completely.

Preparation of photosensitive adhesive including diazonaphthoquinone photosensitive resin: mix 15 wt % acrylic resin (purchased from Changzhou Hanguang Paint Co., Ltd., with brand name as AR-2070), 5 wt % diazonaphthoquinone photosensitive resin, 0.03 wt % solvent blue RS, 0.2 wt % dinitrobenzyl p-toluenesulfonate, and dipropylene glycol dimethyl ether that accounts for the remaining percentage, then dissolve the components completely, and then filter the mixture, wherein:

The diazonaphthoquinone photosensitive resin is obtained through a reaction between diazonaphthoquinone sulfuryl chloride and phenolic novolac resin (purchased from Shandong Shengquan Chemical Co., Ltd., with brand name as SH-1) catalyzed by 30 wt % water solution of sodium dihydrogen phosphate, and the grafting ratio of the diazonaphthoquinone sulfuryl chloride on the phenolic novolac resin is 15 wt %; the photosensitive groups in the diazonaphthoquinone sulfuryl chloride are diazonaphthoquinone groups.

Preparation of ink-repulsive liquid: mix 10 wt % silicone rubber (purchased from Dongguan Hongya OrganicSilicone Co., Ltd., viscosity: 10,000 cp.), 1 wt % silicon-nitrogen polymer (prepared with the synthesis method for the silicon-nitrogen polymer C disclosed in Chinese patent 93117927.0), and octane that accounts for the remaining percentage, to obtain an ink-repulsive liquid.

Wash an aluminum plate substrate not subjected to electrolytic graining and anodic oxidation treatment with water, treat for 20 s in a water solution that contains 0.2 wt % sodium hydroxide and 10 wt % sodium carbonate to de-oil, and then wash with water again, to remove residual alkaline liquid, and then dry.

Coat the base coat liquid by spin-coating on the surface of the de-oiled aluminum plate substrate, and then dry the aluminum plate substrate for 3 min at 90° C. to obtain a base coat layer in thickness of 2 μm; coat the photosensitive adhesive including diazonaphthoquinone photosensitive resin by spin-coating on the surface of the base coat layer, and then dry for 5 min at 90° C. to obtain a photosensitive adhesive layer in thickness of 35 μm; coat the ink-repulsive liquid by spin-coating on the surface of the dry diazonaphthoquinone photosensitive adhesive layer, and then lay aside for 2 days at room temperature, to obtain an ink-repulsive layer in thickness of 3 μm. Cover a polyester film in thickness of 3 μm on the surface of the ink-repulsive layer, so as to obtain an environment friendly waterless offset plate.

### Example 8

Preparation of base coat liquid: mix 15 wt % melamine formaldehyde resin (purchased from Yixing Yincheng Chemical Co., Ltd.), 5 wt % Nb₁₀ZrO₂₇, 3 wt % anti-halation zinc oxide in 70 nm particle size, and ethyl alcohol that accounts for the remaining percentage, stir well, and grind, so that the components in the obtained base coat liquid are dissolved and dispersed completely.

Preparation of photosensitive adhesive including diazonaphthoquinone photosensitive resin: mix 15 wt % polyvinyl acetal (purchased from Shanghai Meimengjia Chemical Technology Co., Ltd.), 4 wt % diazonaphthoquinone photosensitive resin, 0.1 wt % aniline black, 0.3 wt % n-trifluoromethane sulfonyloxy naphthalimide, and ethylene glycol monomethyl ether acetate that accounts for the remaining percentage, then dissolve the components completely, and then filter the mixture, wherein:

The diazonaphthoquinone photosensitive resin is obtained through a reaction between diazonaphthoquinone sulfuryl chloride and phenol resin (prepared through a reaction between pyrogallol and formaldehyde at 1:3 mole ratio under acidic condition at 70° C.) catalyzed by 15 wt % water solution of sodium phosphate, and the grafting ratio of the diazonaphthoquinone sulfuryl chloride on the phenol resin is 10 wt %; the photosensitive groups in the diazonaphthoquinone sulfuryl chlorides are diazonaphthoquinone groups.

Preparation of ink-repulsive liquid: mix 9 wt % fluorosilicone epoxy resin (purchased from Shenzhen Jipeng Fluorine Silicone Co., Ltd.), 1 wt % low molecular weight polyamide (amine value: 300˜400 mg KOH/g), and dimethyl benzene that accounts for the remaining percentage, to obtain an ink-repulsive liquid.

Wash an aluminum plate substrate not subjected to electrolytic graining and anodic oxidation treatment with water, treat for 15 s in a water solution that contains 0.5 wt % sodium hydroxide, 0.5 wt % sodium hydrogen phosphate, and 1 wt % sodium bicarbonate to de-oil, and then wash with water again, to remove residual alkaline liquid, and then dry.

Coat the base coat liquid by spin-coating on the surface of the de-oiled aluminum plate substrate, and then dry the aluminum plate substrate for 2 min at 100° C. to obtain a base coat layer in thickness of 2 μm; coat the photosensitive adhesive including diazonaphthoquinone photosensitive resin by spin-coating on the surface of the base coat layer, and then dry for 4 min at 100° C. to obtain a photosensitive adhesive layer in thickness of 25 μm; coat the ink-repulsive liquid by spin-coating on the surface of the dry diazonaphthoquinone photosensitive adhesive layer, and then lay aside for 2 days at room temperature, to obtain an ink-repulsive layer in thickness of 4 μm. Cover a nylon film in thickness of 4 μm on the surface of the ink-repulsive layer, so as to obtain an environment friendly waterless offset plate.

### Example 9

Preparation of base coat liquid: mix 25 wt % alkyd resin (purchased from Jiangsu Hualun Chemical Co., Ltd., with brand name as BD251), 2 wt % silane coupling agent (purchased from Jiangsu Chenguang Coupling Agent Co., Ltd., with brand name as KH550), 1 wt % anti-halation silicon dioxide in 150 nm particle size, and dimethyl benzene that accounts for the remaining percentage, stir well, and grind, so that the components in the obtained base coat liquid are dissolved and dispersed completely.

Preparation of photosensitive adhesive including diazonaphthoquinone photosensitive resin: mix 10 wt % phenolic novolac resin (purchased from Shandong Shengquan Chemical Co., Ltd., with brand name as SH-1), 5 wt % epoxy resin (purchased from Borui Resin Materials Trading Firm in Sanxiang Town, Zhongshan, with brand name as 618), 4 wt % diazonaphthoquinone photosensitive resin, 0.01 wt % basic brilliant blue, 0.09 wt % 2,4-di-(trichloromethyl)-6-p-methoxy-styryl-s-triazine, and propylene glycol butyl ether that accounts for the remaining percentage, then dissolve the components completely, and filter the mixture, wherein:

The diazonaphthoquinone photosensitive resin is obtained through a reaction between diazonaphthoquinone sulfuryl chloride and phenolic novolac resin (purchased from Shandong Shengquan Chemical Co., Ltd., with brand name as SH-1) catalyzed by a water solution that contains 20 wt % sodium bicarbonate and 0.2 wt % sodium hydroxide, and the grafting ratio of the diazonaphthoquinone sulfuryl chloride on the phenolic novolac resin is 30 wt %; the photosensitive groups in the diazonaphthoquinone sulfuryl chloride are diazonaphthoquinone groups.

Preparation of ink-repulsive liquid: mix 20 wt % silicone rubber (purchased from Shenzhen Chuying Chemical Co., Ltd., with brand name as 107), 2 wt % silicon-nitrogen polymer (prepared with the synthesis method for the silicon-nitrogen polymer C disclosed in Chinese patent 93117927.0), and n-heptane that accounts for the remaining percentage, to obtain an ink-repulsive liquid.

Wash an aluminum plate substrate not subjected to electrolytic graining and anodic oxidation treatment with water, treat for 15 s in 5 wt % water solution of potassium hydroxide to de-oil, and then wash with water again, to remove residual alkaline liquid, and then dry.

Coat the base coat liquid by roller coating on the surface of the de-oiled aluminum plate substrate, and then dry the aluminum plate substrate for 3 min at 110° C. to obtain a base coat layer in thickness of 3 μm; coat the photosensitive adhesive including diazonaphthoquinone photosensitive resin by roller coating on the surface of the base coat layer, and then dry for 8 min at 100° C. to obtain a photosensitive adhesive layer in thickness of 40 μm; coat the ink-repulsive liquid by roller coating on the surface of the dry diazonaphthoquinone photosensitive adhesive layer, and then lay aside for 1 day at 70° C., to obtain an ink-repulsive layer in thickness of 2 μm. Cover a polyester film in thickness of 5 μm on the surface of the ink-repulsive layer, so as to obtain an environment friendly waterless offset plate.

### Example 10

Preparation of base coat liquid: mix 40 wt % ethylene-vinyl acetate copolymer (purchased from Dongguan Tongfu Plastic Trading Co., Ltd., with brand name as EVA/14J6), 3 wt % titanate coupling agent (purchased from Nanjing Shuguang Chemical Group Co., Ltd., with brand name as SG-TnBT), 5 wt % anti-halation aluminum oxide in 700 nm particle size, and methylbenzene that accounts for the remaining percentage, stir well, and grind, so that the components in the obtained base coat liquid are dissolved and dispersed completely.

Preparation of photosensitive adhesive including diazonaphthoquinone photosensitive resin: mix 15 wt % phenolic novolac resin (purchased from Liaoning Xinggang Friction Materials Co., Ltd., with brand name as 2123), 5 wt % polyurethane (purchased from Yantai Wanhua Polyurethane Co., Ltd., with brand name as WANNATE PM-2025), 5 wt % epoxy resin (purchased from Borui Resin Materials Trading Firm in Sanxiang Town, Zhongshan, with brand name as 618) 5 wt % diazonaphthoquinone photosensitive resin, 0.2 wt % methyl violet, 0.3 wt % 2,4-di-(trichloromethyl)-6-p-methoxy-styryl-s-triazine, 20 wt % glycol ether, and butanone that accounts for the remaining percentage, then dissolve the components completely, and then filter the mixture, wherein:

The diazonaphthoquinone photosensitive resin is obtained through a reaction between diazonaphthoquinone sulfuryl chloride and phenolic phenol resin (prepared through a reaction between pyrogallol and formaldehyde at 1:2 mole ratio under acidic condition at 70° C.) catalyzed by a water solution that contains 10 wt % potassium hydrogen phosphate and 0.3 wt % potassium hydroxide, and the grafting ratio of the diazonaphthoquinone sulfuryl chloride on the phenolic phenol resin is 25 wt %; the photosensitive groups in the diazonaphthoquinone sulfuryl chlorides are diazonaphthoquinone groups.

Preparation of ink-repulsive liquid: mix 15 wt % silicone rubber (purchased from Shishi Luyu Chemical Trading Co., Ltd., viscosity: 2,000 cp.), 0.5 wt % butyltin dilaurate, and n-pentane that accounts for the remaining percentage, to obtain an ink-repulsive liquid.

Wash an aluminum plate substrate not subjected to electrolytic graining and anodic oxidation treatment with water, treat for 15 s in a water solution that contains 10 wt % potassium hydrogen phosphate and 0.05 wt % potassium hydroxide to de-oil, and then wash with water again, to remove residual alkaline liquid, and then dry.

Coat the base coat liquid by spin-coating on the surface of the de-oiled aluminum plate substrate, and then dry the aluminum plate substrate for 5 min at 150° C. to obtain a base coat layer in thickness of 4 μm; coat the photosensitive adhesive including diazonaphthoquinone photosensitive resin by spin-coating on the surface of the base coat layer, and then dry for 5 min at 100° C. to obtain a photosensitive adhesive layer in thickness of 30 μm; coat the ink-repulsive liquid by roller coating on the surface of the dry diazonaphthoquinone photosensitive adhesive layer, and then lay aside for 3 days at room temperature, to obtain an ink-repulsive layer in thickness of 4 μm. Cover a polyethylene film in thickness of 2 μm on the surface of the ink-repulsive layer, so as to obtain an environment friendly waterless offset plate.

### Example 11

Preparation of base coat liquid: mix 10 wt % unsaturated polyester resin (purchased from Jinan Oasis Composite Materials Co., Ltd., with brand name as 902D#), 0.05 wt % hydroxyethyl acrylate, 0.2 wt % anti-halation titanium dioxide in 100 nm particle size, and n-methylpyrrolidone (NMP) that accounts for the remaining percentage, stir well, and grind, so that the components in the obtained base coat liquid are dissolved and dispersed completely.

Preparation of photosensitive adhesive including diazonaphthoquinone photosensitive resin: mix 15 wt % acrylic resin (purchased from Changzhou Hanguang Paint Co., Ltd., with brand name as AR-2070), 5 wt % diazonaphthoquinone photosensitive resin, 0.03 wt % solvent blue RS, 0.2 wt % dinitrobenzyl p-toluenesulfonate, and dipropylene glycol dimethyl ether that accounts for the remaining percentage, then dissolve the components completely, and then filter the mixture, wherein:

The diazonaphthoquinone photosensitive resin is obtained through a reaction between diazonaphthoquinone sulfuryl chloride and phenol resin (prepared through a reaction between pyrogallol and formaldehyde at 1:4 mole ratio under alkaline condition at 75° C.) catalyzed by 3 wt % water solution of potassium phosphate, and the grafting ratio of the diazonaphthoquinone sulfuryl chloride on the phenol resin is 15 wt %; the photosensitive groups in the diazonaphthoquinone sulfuryl chlorides are diazonaphthoquinone groups.

Preparation of ink-repulsive liquid: mix 10 wt % silicone rubber (purchased from Dongguan Hongya OrganicSilicone Co., Ltd., viscosity: 20,000 cp.), 1 wt % silicon-nitrogen polymer (prepared with the synthesis method for the silicon-nitrogen polymer C disclosed in Chinese patent 93117927.0), and octane that accounts for the remaining percentage, to obtain an ink-repulsive liquid.

Wash an aluminum plate substrate not subjected to electrolytic graining and anodic oxidation treatment with water, treat for 20 s in a water solution that contains 0.2 wt % sodium hydroxide and 10 wt % sodium carbonate to de-oil, and then wash with water again, to remove residual alkaline liquid, and then dry.

Coat the base coat liquid by spin-coating on the surface of the de-oiled aluminum plate substrate, and then dry the alloy plate substrate for 3 min at 100° C. to obtain a base coat layer in thickness of 4 μm; coat the photosensitive adhesive including diazonaphthoquinone photosensitive resin by spin-coating on the surface of the base coat layer, and then dry for 3 min at 100° C. to obtain a photosensitive adhesive layer in thickness of 40 μm; coat the ink-repulsive liquid by spin-coating on the surface of the dry diazonaphthoquinone photosensitive adhesive layer, and then lay aside for 2 days at 80° C., to obtain an ink-repulsive layer in thickness of 2 μm. Cover a polystyrene film in thickness of 5 μm on the surface of the ink-repulsive layer, so as to obtain an environment friendly waterless offset plate.

### Example 12

Preparation of base coat liquid: mix 5 wt % epoxy resin (purchased from Borui Resin Material Trading Firm in Sanxiang Town, Zhongshan, with brand name as 618), 3 wt % dipropylene glycol diacrylate, 0.5 wt % anti-halation zinc oxide nanometer particles in 30 nm particle size, and n-methylpyrrolidone (NMP) that accounts for the remaining percentage, stir well, and grind, so that the components in the obtained base coat liquid are dissolved and dispersed completely.

Preparation of photosensitive adhesive including diazonaphthoquinone photosensitive resin: mix 15 wt % alkyd resin (purchased from Jiangsu Hualun Chemical Co., Ltd., with brand name as BD251), 6 wt % diazonaphthoquinone photosensitive resin, 0.01 wt % Victoria blue, 0.02 wt % sulfonium salt (purchased from Liyie Chemical Co., Ltd. in Handan Development Zone), and diethylene glycol dimethyl ether that accounts for the remaining percentage, then dissolve the components completely, and then filter the mixture, wherein:

The diazonaphthoquinone photosensitive resin is obtained through a reaction between diazonaphthoquinone sulfuryl chloride and phenol resin (prepared through a reaction between pyrogallol and formaldehyde at 1:3 mole ratio under acidic condition at 80° C.) catalyzed by 3 wt % water solution of potassium phosphate, and the grafting ratio of the diazonaphthoquinone sulfuryl chloride on the phenol resin is 15 wt %; the photosensitive groups in the diazonaphthoquinone sulfuryl chlorides are diazonaphthoquinone groups.

Preparation of ink-repulsive liquid: mix 15 wt % silicone rubber (purchased from Dongguan Hongya OrganicSilicone Co., Ltd., viscosity: 15,000 cp.), 0.75 wt % hydrosilicone oil (purchased from Shin-Etsu Chemical Co., Ltd., with brand name as KF-99) and isoparaffin-H that accounts for the remaining percentage (purchased from Shenzhen Goforward Technology Co., Ltd.), to obtain an ink-repulsive liquid.

Wash an alloy plate substrate (aluminum-zinc alloy plate that contains 1˜3 wt % zinc) not subjected to electrolytic graining and anodic oxidation treatment with water, treat for 20 s in 1 wt % water solution of potassium hydroxide to de-oil, and then wash with water again, to remove residual alkaline liquid, and then dry.

Coat the base coat liquid by spin-coating on the surface of the de-oiled alloy plate substrate, and then dry the alloy plate substrate for 6 min at 90° C. to obtain a base coat layer in thickness of 7 μm; coat the photosensitive adhesive including diazonaphthoquinone photosensitive resin by spin-coating on the surface of the base coat layer, and then dry for 3 min at 100° C. to obtain a photosensitive adhesive layer in thickness of 30 μm; coat the ink-repulsive liquid by spin-coating on the surface of the dry diazonaphthoquinone photosensitive adhesive layer, and then lay aside for 0.5 day at 100° C., to obtain an ink-repulsive layer in thickness of 3 μm. Cover a polyvinyl chloride film in thickness of 5 μm on the surface of the ink-repulsive layer, so as to obtain an environment friendly waterless offset plate.

### Example 13

Preparation of base coat liquid: mix 25 wt % polyacrylic resin (purchased from Changzhou Hanguang Paint Co., Ltd., with brand name as AR-2070), 10 wt % trimethylolpropane triacrylate, 0.3 wt % anti-halation zirconium oxide nanometer particles in 50 nm particle size, and n-methyl pyrrolidone (NMP) that accounts for the remaining percentage, stir well, and grind, so that the components in the obtained base coat liquid are dissolved and dispersed completely.

Preparation of photosensitive adhesive including diazonaphthoquinone photosensitive resin: mix 5 wt % phenolic novolac resin (purchased from Shanghai Dajin Photosensitive Materials Co., Ltd., with brand name as 210), 3 wt % diazonaphthoquinone photosensitive resin, 0.05 wt % oil blue B, 0.05 wt % 2,4-di-(trichloromethyl)-6-p-methoxy-styryl-s-triazine, and glycol ether that accounts for the remaining percentage, then dissolve the components completely, and then filter the mixture, wherein:

The diazonaphthoquinone photosensitive resin is obtained through a reaction between diazonaphthoquinone sulfuryl chloride and phenolic novolac resin (purchased from Shanghai Dajin Photosensitive Materials Co., Ltd., with brand name as 210) catalyzed by 0.1 wt % water solution of sodium hydroxide, and the grafting ratio of the diazonaphthoquinone sulfuryl chloride on the phenolic novolac resin is 10 wt %; the photosensitive groups in the diazonaphthoquinone sulfuryl chloride are diazonaphthoquinone groups.

Preparation of ink-repulsive liquid: mix 30 wt % organo-fluorine modified acrylic resin (purchased from Keyao Chemical Co., Ltd. under Shandong Dongming Petrochemical Group, with brand name as CF-902), 2 wt % hexamethylene diisocyanate, and dimethyl benzene that accounts for the remaining percentage.

Wash a zinc plate substrate not subjected to electrolytic graining and anodic oxidation treatment with water, treat for 5 s in 40 wt % water solution of sodium phosphate to de-oil, and then wash with water again, to remove residual alkaline liquid, and then dry.

Coat the base coat liquid by spin-coating on the surface of the de-oiled zinc plate substrate, and then dry the alloy plate substrate for 10 min at 80° C. to obtain a base coat layer in thickness of 4 μm; coat the photosensitive adhesive made of diazonaphthoquinone photosensitive resin by spin-coating on the surface of the base coat layer, and then dry for 10 min at 80° C. to obtain a photosensitive adhesive layer in thickness of 20 μm; coat the ink-repulsive liquid by spin-coating on the surface of the dry diazonaphthoquinone photosensitive adhesive layer, and then lay aside for 2 days at room temperature, to obtain an ink-repulsive layer in thickness of 5 μm. Cover a polyethylene film in thickness of 5 μm on the surface of the ink-repulsive layer, so as to obtain an environment friendly waterless offset plate.

### Example 14

Preparation of base coat liquid: mix 15 wt % polymethacrylic resin (purchased from Jinan Yuanxiang Chemical Co., Ltd., with brand name as BC-201-805), 5 wt % pentaerythritol tetraacrylate, 1 wt % anti-halation silicon carbide nanometer particles in 60 nm particle size, and n-methylpyrrolidone (NMP) that accounts for the remaining percentage, stir well, and grind, so that the components in the obtained base coat liquid are dissolved and dispersed completely.

Preparation of photosensitive adhesive including diazonaphthoquinone photosensitive resin: mix 10 wt % phenolic novolac resin (purchased from Shanghai Dajin Photosensitive Materials Co., Ltd., with brand name as 213), 5 wt % epoxy resin (purchased from Borui Resin Materials Trading Firm in Sanxiang Town, Zhongshan, with brand name as 618), 4 wt % diazonaphthoquinone photosensitive resin, 0.01 wt % basic brilliant blue, 0.09 wt % 2,4-di-(trichloromethyl)-6-p-methoxy-styryl-s-triazine, and propylene glycol butyl ether that accounts for the remaining percentage, then dissolve the components completely, and then filter the mixture, wherein:

The diazonaphthoquinone photosensitive resin is obtained through a reaction between diazonaphthoquinone sulfuryl chloride and phenolic novolac resin (purchased from Liaoning Xinggang Friction Materials Co., Ltd., with brand name as 2123) catalyzed by a water solution that contains 20 wt % sodium bicarbonate and 0.2 wt % sodium hydroxide, and the grafting ratio of the diazonaphthoquinone sulfuryl chloride on the phenolic novolac resin is 30 wt %; the photosensitive groups in the diazonaphthoquinone sulfuryl chloride are diazonaphthoquinone groups.

Preparation of ink-repulsive liquid: mix 15 wt % silicone rubber (purchased from Shishi Luyu Chemical Trading Co., Ltd., viscosity: 4,000 cp.), 0.75 wt % hydrosilicone oil (purchased from Shin-Etsu Chemical Co., Ltd., with brand name as KF-99) and isoparaffin-H that accounts for the remaining percentage (purchased from Shenzhen Goforward Technology Co., Ltd.), to obtain an ink-repulsive liquid.

Wash an alloy plate substrate (aluminum-zinc alloy plate that contains 1˜3 wt % zinc) not subjected to electrolytic graining and anodic oxidation treatment with water, treat for 20 s in 1 wt % water solution of potassium hydroxide to de-oil, and then wash with water again, to remove residual alkaline liquid, and then dry.

Coat the base coat liquid by spin-coating on the surface of the de-oiled alloy plate substrate, and then dry the alloy plate substrate for 5 min at 90° C. to obtain a base coat layer in thickness of 5 μm; coat the photosensitive adhesive including diazonaphthoquinone photosensitive resin by spin-coating on the surface of the base coat layer, and then dry for 4 min at 100° C. to obtain a photosensitive adhesive layer in thickness of 35 μm; coat the ink-repulsive liquid by spin-coating on the surface of the dry diazonaphthoquinone photosensitive adhesive layer, and then lay aside for 3 day at room temperature, to obtain an ink-repulsive layer in thickness of 3 μm. Cover a polystyrene film in thickness of 5 μm on the surface of the ink-repulsive layer, so as to obtain an environment friendly waterless offset plate.

### Example 15

Preparation of base coat liquid: mix 10 wt % dodecyl acrylate, 5 wt % ethylene oxide-modified trimethylolpropane triacrylate (obtained from a reaction between ethylene oxide and trimethylolpropane triacrylate at 4:1 mole ratio for 4 h at 70° C.), 0.05 wt % anti-halation aluminum oxide nanometer particles in 400 nm particle size, and n-methylpyrrolidone (NMP) that accounts for the remaining percentage, stir well, and grind, so that the components in the obtained base coat liquid are dissolved and dispersed completely.

Preparation of photosensitive adhesive including diazonaphthoquinone photosensitive resin: mix 15 wt % alkyd resin (purchased from Jiangsu Hualun Chemical Co., Ltd., with brand name as BD251), 6 wt % diazonaphthoquinone photosensitive resin, 0.01 wt % Victoria blue, 0.02 wt % sulfonium salt (purchased from Liyie Chemical Co., Ltd. in Handan Development Zone), and diethylene glycol dimethyl ether that accounts for the remaining percentage, then dissolve the components completely, and then filter the mixture, wherein:

The diazonaphthoquinone photosensitive resin is obtained through a reaction between diazonaphthoquinone sulfuryl chloride and phenol resin (prepared through a reaction between pyrogallol and formaldehyde at 1:0.2 mole ratio under acidic condition at 70° C.) catalyzed by 3 wt % water solution of potassium phosphate, and the grafting ratio of the diazonaphthoquinone sulfuryl chloride on the phenol resin is 15 wt %; the photosensitive groups in the diazonaphthoquinone sulfuryl chlorides are diazonaphthoquinone groups.

Preparation of ink-repulsive liquid: mix 15 wt % silicone rubber (purchased from Shishi Luyu Chemical Trading Co., Ltd., viscosity: 2,500 cp.), 0.75 wt % hydrosilicone oil (purchased from Shin-Etsu Chemical Co., Ltd., with brand name as KF-99) and isoparaffin-H that accounts for the remaining percentage (purchased from Liyie Chemical Co., Ltd. in Handan Development Zone), to obtain an ink-repulsive liquid.

Wash an alloy plate substrate (aluminum-zinc alloy plate that contains 1˜3 wt % zinc) not subjected to electrolytic graining and anodic oxidation treatment with water, treat for 20 s in 1 wt % water solution of potassium hydroxide to de-oil, and then wash with water again, to remove residual alkaline liquid, and then dry.

Coat the base coat liquid by spin-coating on the surface of the de-oiled alloy plate substrate, and then dry the alloy plate substrate for 2 min at 100° C. to obtain a base coat layer in thickness of 20 μm; coat the photosensitive adhesive including diazonaphthoquinone photosensitive resin by spin-coating on the surface of the base coat layer, and then dry for 2 min at 110° C. to obtain a photosensitive adhesive layer in thickness of 25 μm; coat the ink-repulsive liquid by spin-coating on the surface of the dry diazonaphthoquinone photosensitive adhesive layer, and then lay aside for 1 day at room temperature, to obtain an ink-repulsive layer in thickness of 5 μm. Cover a polypropylene film in thickness of 10 μm on the surface of the ink-repulsive layer, so as to obtain an environment friendly waterless offset plate.

The polymer protective film prepared in any of the above examples 1˜15 should be removed when the environment friendly waterless offset plate is to be used; then, the environment friendly waterless offset plate can be treated through a plate making process, including exposure, development, and fixation, etc.; next, the plate with images and text can be directly used for printing in a printing press. The waterless offset plate prepared in any of the examples 1˜45 has high printing adaptability and the pressrum is up to 10,000˜30,000 press-runs.

1. An environment friendly waterless offset plate, obtained by coating a base coat layer on the surface of a metal plate substrate not subjected to electrolytic graining and/or anodic oxidation treatment but subjected to oil-removal solution immersion instead, coating a diazonaphthoquinone photosensitive adhesive layer on the surface of the base coat layer, and coating an ink-repulsive layer on the surface of the diazonaphthoquinone photosensitive adhesive layer;
the base coat layer is a coating formed by spreading a base coat liquid constituted by 0˜50 wt % polymer, 0.01˜20 wt % metal adhesion promoter, 0.01˜20 wt % anti-halation nanometer particles, and organic solvent that accounts for the remaining percentage on the surface of the metal plate substrate and the drying the coating;
the ink-repulsive layer is a coating formed by spreading an ink-repulsive liquid constituted by 5˜30 wt % silicone rubber or fluoro resin, 0.01˜2 wt % curing agent, and organic solvent that accounts for the remaining percentage on the surface of the diazonaphthoquinone photosensitive adhesive layer and then drying the coating.

2. The environment friendly waterless offset plate according to claim 1, wherein, the base coat layer is in thickness of 1˜20 μm; the diazonaphthoquinone photosensitive adhesive layer is in thickness of 10˜50 μm; the ink-repulsive layer is in thickness of 2˜5 μm.

3. The environment friendly waterless offset plate according to claim 1, wherein, the polymer is at least one selecting from the group consisting of polyvinyl butyral, polyurethane, polyacrylic resin, polymethacrylic resin, phenolic resin, epoxy resin, melamine formaldehyde resin, polyester resin, alkyd resin, and ethylene-vinyl acetate copolymer;
the metal adhesion promoter is at least one selecting from the group consisting of silane coupling agent, titanate coupling agent, aryl phosphate ester, alkyl phosphate ester, zirconium aluminate, zirconate, hydroxyethyl acrylate, hydroxy-propyl acrylate, dodecyl acrylate, octadecyl acrylate, 2-ethylhexyl acrylate, butyl acrylate, ethoxylated cyclohexanol acrylate, isoborneol acrylate, epoxy acrylic ester, ethoxy-ethyl acrylate, 2-phenoxy-ethyl methacrylate, polyethylene glycol-200 diacrylate, polyethylene glycol-400 diacrylate, polyethylene glycol-600 diacrylate, tripropylene glycol diacrylate, dipropylene glycol diacrylate, propylene glycol diacrylate, neopentyl glycol diacrylate, neopentyl glycol benzoate acrylate, propoxy-2 neopentyl glycol diacrylate, nonyl-phenoxy polyethylene glycol acrylate, 1,3-butanediol diacrylate, phthalate diglycol diacrylate, phthalate tripropylene glycol diacrylate, ethylene glycol diacrylate, diethylene glycol diacrylate, triethylene glycol diacrylate, tetraethylene glycol diacrylate, 1,6-hexanediol diacrylate, ethoxylated 1,6-hexanediol diacrylate, 1,4-butanediol diacrylate, ethoxy-4 bisphenol A diacrylate, acryloyl morpholine, trimethylolpropane triacrylate, ethylene oxide-modified trimethylolpropane triacrylate, ethoxylated trimethylolpropane diacrylate, propoxylated trimethylolpropane triacrylate, propoxylated 3-glycerol triacrylate, pentaerythritol tetraacrylate, pentaerythritol triacrylate, and dipentaerythritol pentaacrylate;
the anti-halation nanometer particles are in 10˜1,000 nm particle size, and are at least one selecting from the group consisting of aluminum oxide nanometer particles, zinc oxide nanometer particles, silicon dioxide nanometer particles, zirconium oxide nanometer particles, titanium oxide nanometer particles, and silicon carbide nanometer particles;
the organic solvent in the base coat liquid is selected from alcohol, ketone, ether, ester, or hydrocarbon.

4. The environment friendly waterless offset plate according to claim 3, wherein, the aryl in the aryl phosphate ester is selected from phenyl, tolyl, or naphthyl;
the alkyl in the alkyl phosphate esters is selected from C1-C20 alkyl chains;
the zirconium aluminate is selected from zirconium potassium aluminate, zirconium sodium aluminate, or a mixture thereof;
the zirconate is at least one selecting from the group consisting of M²⁺ZrO₃, M³⁺Zr₂O₇, M₄³⁺Zr₃O₁₂, Ti—ZrO₄, V₂ZrO₇, Nb₁₀ZrO₂₇, MO₂ZrO₄ and W₂ZrO₈, wherein:
the M in M²⁺ZrO₃ is one selecting from bivalent magnesium, barium, strontium and calcium; the M in M³⁺Zr₂O₇ is one selecting from lanthanum, cerium, neodymium, and samarium; the M in M₄³⁺Zr₃O₁₂ is selected from scandium or ytterbium.

5. The environment friendly waterless offset plate according to claim 3, wherein, the alcohol is selected from C1˜C5 monohydric alcohol or C2˜C5 dihydric alcohol or trihydric alcohol;
the ketone is one selecting from acetone, butanone, cyclohexanone, and n-methylpyrrolidone (NMP);
the ether is one selecting from ethylene glycol monoethyl ether, ethylene glycol monoethyl ether, ethylene glycol mono-n-dutyl ether, glycol dimethyl ether, ethylene glycol diethyl ether, propylene glycol monomethyl ether, propylene glycol monoethyl ether, propylene glycol dimethyl ether, and propylene glycol diethyl ether;
the ester is one selecting from ethyl acetate, methyl acetate, ethyl formate, butyl formate, and propylene glycol monomethyl ether acetate;
the hydrocarbon is one selecting from normal heptane, normal hexane, methyl benzene, and dimethyl benzene.

6. The environment friendly waterless offset plate according to claim 1, wherein, the diazonaphthoquinone photosensitive adhesive layer is a coating formed by spreading a photosensitive adhesive constituted by 5˜30 wt % film forming resin, 1˜20 wt % diazonaphthoquinone photosensitive resin, 0.01˜0.5 wt % background dye, 0.01˜0.5 wt % acid generator, and organic solvent that accounts for the remaining percentage on the surface of the base coat layer and then drying the coating.

7. The environment friendly waterless offset plate according to claim 6, wherein, the film forming resin is at least one selecting from the group consisting of phenolic resin, urethane resin, epoxy resin, alkyd resin, acrylic resin, polyvinyl formal, polyvinyl acetal, and polyvinyl butyral;
the diazonaphthoquinone photosensitive resin is obtained through a reaction between diazonaphthoquinone sulfuryl chloride and a resin ester catalyzed by 0.1˜50 wt % water solution of an alkaline substance; the grafting ratio of diazonaphthoquinone sulfuryl chloride on the resin ester is 10˜40 wt %;
the resin ester is selected from phenolic novolac resin or phenol resin;
the alkaline substance is at least one selecting from the group consisting of sodium carbonate, potassium carbonate, sodium bicarbonate, potassium bicarbonate, sodium hydroxide, potassium hydroxide, sodium phosphate, potassium phosphate, sodium hydrogen phosphate, potassium hydrogen phosphate, sodium dihydrogen phosphate, and potassium dihydrogen phosphate;
the background dye is one select phenolic from oil yellow, oil red G, oil violet red, oil blue B, oil ethereal blue, solvent blue RS, aniline black, oil black, solvent black 827, solvent black 834, Victoria blue, methyl violet, basic brilliant blue, crystal violet and methyl violet;
the acid generator is selected from onium salt, triazine acid generator or sulphonic acid ester.

8. The environment friendly waterless offset plate according to claim 7, wherein, the onium salt is selected from sulfonium salt, iodonium salt, or a mixture thereof;
the triazine acid generator is selected from 2,4-di-(trichloromethyl)-6-p-methoxy-styryl-s-triazine, 4,6-di-(trichloromethyl)-1,3,5-triazine, or a mixture thereof;
the sulphonic acid ester is at least one selecting from the group consisting of N-hydroxy phthalimide p-toluenesulfonate, N-p-toluenesulfonyloxy phthalimide, N-trifluoromethane sulfonyloxy succinimide, N-trifluoromethane sulfonyloxy naphthalimide, and dinitrobenzyl p-toluenesulfonate.

9. The environment friendly waterless offset plate according to claim 6, wherein, the organic solvent in the photosensitive adhesive is at least one selecting from the group consisting of glycol ether, propylene glycol monomethyl ether, propylene glycol ether, ethylene glycol mono-n-dutyl ether, ethylene glycol dimethyl ether, propylene glycol isopropyl ether, propylene glycol monobutyl ether, propylene glycol dibutyl ether, diethylene glycol monomethyl ether, diethylene glycol monoethyl ether, diethylene glycol dimethyl ether, diethylene glycol diethyl ether, diethylene glycol monobutyl ether, dipropylene glycol monomethyl ether, dipropylene glycol dimethyl ether, dipropylene glycol diethyl ether, dipropylene glycol dipropyl ether, dipropylene glycol monoethyl ether, dipropylene glycol monobutyl ether, triethylene glycol monoethyl ether, triethylene glycol monobutyl ether, tripropylene glycol monomethyl ether, ethylene glycol, propylene glycol, glycerol, diethylene glycol and triethylene glycol, propylene glycol monomethyl ether acetate, ethylene glycol monomethyl ether acetate, and butanone.

10. The environment friendly waterless offset plate according to claim 1, wherein, the viscosity range of the silicone rubber is 1,000˜80,000 cp.;
the fluoro resin is one selecting from organo-fluorine modified acrylic resin, fluorosilicone epoxy resin, and fluoro-rubber.
the curing agent for curing the silicone rubber is one selecting from ethyl orthosilicate, silicon-nitrogen polymer expressed by the following molecular formula (I), butyltin dilaurate, dibutyltin dilaurate, hydrosilicone oil, and chloroplatinic acid, 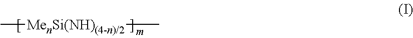
in the formula (I), n=1˜2, and m=100˜200;
the curing agent for curing the fluoro resin is one selecting from hexamethylene diisocyanate, low molecular weight polyamide, and dicyandiamide.

11. The environment friendly waterless offset plate according to claim 1, wherein, the organic solvent in the ink-repulsive liquid is one selecting from n-decane, octane, n-heptane, n-hexane, n-pentane, dimethyl benzene, isoparaffin-E, isoparaffin-G, isoparaffin-H, and ethyl acetate.

12. The environment friendly waterless offset plate according to claim 1, wherein, the surface of the ink-repulsive layer is covered with a polymer protective film.

13. The environment friendly waterless offset plate according to claim 1, wherein, the metal plate substrate is aluminum plate substrate, zinc plate substrate, or alloy plate substrate.

14. The environment friendly waterless offset plate according to claim 13, wherein, the alloy plate substrate is a silicon dioxide-aluminum alloy plate substrate that contains 30˜60 wt % silicon dioxide, or an aluminum-zinc alloy plate substrate that contains 1˜3 wt % zinc, or a ferro-aluminum alloy plate substrate that contains 0.1˜1 wt % iron.
